(19) United States
(12) Patent Application Publication
(10) Pub. No.: US 2009/0235323 A1
(43) Pub. Date: Sep. 17, 2009

(54) DIGITAL BROADCAST RECEPTION DEVICE

(75) Inventor: Takafumi Adachi, Osaka (JP)

Correspondence Address: PILLSBURY WINTHROP SHAW PITTMAN, LLP, P.O. BOX 10500, MCLEAN, VA, 22102, US

(73) Assignee: Funai Electric Co., Ltd., Osaka (JP)

(21) Appl. No.: 12/404,650

(22) Filed: Mar. 16, 2009

(30) Foreign Application Priority Data
Mar. 17, 2008 (JP) 2008-067614

(51) Int. Cl. H04N 7/16

(52) U.S. Cl. 725/139

(57) ABSTRACT

A digital broadcast reception device includes a reception means which receives a digital broadcast signal upon a physical channel which has been tuned, and an acquisition means which performs acquisition processing. Acquisition processing is processing to acquire information about virtual channels from said digital broadcast signal. Moreover, this digital broadcast reception device includes a decision means which decides whether or not said acquisition means has been able to acquire said information about virtual channels within said first timeout period, and a change means which changes the timeout period to a second timeout period, if such acquisition has not been possible. And the acquisition means performs the above acquisition processing until said second timeout period has elapsed.

### CROSS REFERENCE

This Nonprovisional application claims priority under 35 U.S.C. § 119(a) on Patent Application No. 2008-067614 filed in Japan on Mar. 17, 2008, the entire contents of which are hereby incorporated by reference.

### BACKGROUND OF THE INVENTION

In recent years, digital television broadcasting is being performed with digital broadcast signals. In digital television broadcasting, a plurality of virtual channels is present for each physical channel. A physical channel is structured as a TS (Transport Stream). The TS is a series of signals in which various signals such as video signals, audio signals, signals which specify the channel numbers of the virtual channels, and so on are multiplexed together. A digital broadcast reception device decodes the TS of the physical channel to which it is tuned, and, by performing predetermined signal processing, acquires, for each physical channel, channel information for the virtual channels present thereupon. The channel information about the virtual channels specifies a main channel and at least one sub-channel which are the virtual channels.

In order to acquire the channel information about the virtual channels, a digital broadcast reception device utilizes a VCT (Virtual Channel Table). However, with a digital broadcast signal, the main channel and the at least one sub-channel of the virtual channels change dynamically. Due to this, when the physical channel is changed, sometimes it happens that the channel information about the virtual channels which was previously acquired and the channel information about the virtual channels which is currently being transmitted are different.

Because of this, each time the physical channel changes, the digital broadcast reception device acquires the VCT anew, and decides what virtual channels are present upon the physical channel that is currently being received. Since, as a standard, the VCT is transmitted every 400 ms, accordingly the digital broadcast reception device is set to a time period of around 500 ms for acquiring the VCT. And the digital broadcast reception device decides whether or not it can acquire the VCT within this timeout period. If the digital broadcast reception device has not been able to acquire the VCT within the timeout period, then it tries to acquire it within a time period of around 500 ms, which is the same as the previous timeout period. And, if the digital broadcast reception device has failed in the acquisition of the VCT for a second time, then it decides that it cannot detect the VCT upon the physical channel to which it is currently tuned, and that it has not been able to acquire the information about the virtual channels.

For example, as may be seen in Japanese Laid-Open Patent Publication 2002-344831, when the physical channel has been changed over, the virtual channels of the physical channel which is currently tuned are registered by acquiring the VCT. Moreover, when it has not been possible to acquire the VCT, then it is decided that this is a digital television broadcast which does not have a VCT.

However sometimes, for one reason or another, it may happen that the VCT is not transmitted in the normal manner. Principal reasons for this to occur are considered to be, for example, that the interval at which the VCT is actually transmitted is not according to the standard, or that the data in the VCT becomes damaged partway through being transmitted from the broadcasting station.

If the interval at which the VCT is transmitted is not according to the standard, then sometimes it may be the case that the time period between consecutive times the VCT is transmitted is set to be a longer time period than 1 s (twice 500 ms) (for example, 1.5 s or 2 s). In this case, the digital broadcast reception device cannot acquire the VCT. Due to this, in this case, the user becomes unable to view programs.

Moreover, if the data in the VCT is damaged, then the digital broadcast reception device is unable to acquire the VCT. Due to this, the user becomes unable to view the programs in this case as well.

Accordingly, the object of the present invention is to provide a digital broadcast reception device which, along with rapidly acquiring the VCT if the VCT is transmitted in a normal manner, also can acquire the VCT simply and easily even if the VCT is not transmitted in a normal manner.

### SUMMARY OF THE INVENTION

The digital broadcast reception device of the present invention comprises a reception means, an acquisition means, a decision means, and a change means. The reception means receives a digital broadcast signal upon a physical channel which has been tuned. And the acquisition means performs acquisition processing until a first timeout period has elapsed. Here, this acquisition processing is processing in which information about virtual channels included upon said digital broadcast signal is acquired from said digital broadcast signal. And the decision means decides whether or not said acquisition means has been able to acquire said information about virtual channels within said first timeout period. This information about virtual channels may be, for example, a VCT (Virtual Channel Table).

The change means changes the first timeout period to a second timeout period, when said decision means has decided that said acquisition means has not been able to acquire said information about virtual channels within said first timeout period. Here, the second timeout period is longer than said first timeout period.

And said acquisition means performs said acquisition processing after said change means has performed change of the timeout period, until said second timeout period has elapsed. Moreover, said decision means decides whether or not said acquisition means has been able to acquire said information about virtual channels within said second timeout period. With the structure described above, if the VCT is transmitted in the normal manner, then this VCT is acquired by the acquisition means during the first timeout period. Moreover, if the VCT is not transmitted in the normal manner, then this VCT is acquired by the acquisition means during the second timeout period.

### BRIEF DESCRIPTION OF THE DRAWINGS

FIG. 1 is a block diagram showing the main structure of a digital television according to an embodiment of the present invention;

FIG. 2 is a flow chart showing operation performed by this digital television according to an embodiment of the present invention;

FIG. 3 is a flow chart showing operation performed for a signal analysis routine A by this digital television according to an embodiment of the present invention;

FIG. 4 is a flow chart showing operation performed for a signal analysis routine B by this digital television according to an embodiment of the present invention; and

FIGS. 5A and 5B show examples of display screens which are displayed upon a display unit.

### DETAILED DESCRIPTION OF THE INVENTION

In the following, a digital television according to an embodiment of the present invention will be explained.

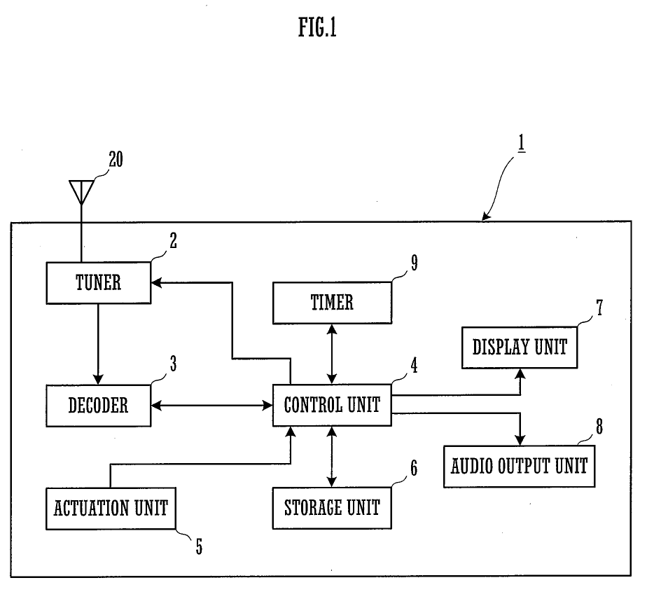

FIG. 1 is a block diagram showing the main structure of a digital television according to an embodiment of the present invention. This digital television 1 comprises a tuner 2, a decoder 3, a control unit 4, an actuation unit 5, a storage unit 6, a display unit 7, an audio output unit 8, and a timer 9.

The tuner 2 is connected to an antenna 20. The tuner 2 separates out a physical channel TS to which it is tuned from a digital broadcast signal received by the antenna 20, and inputs it to the decoder 3.

The decoder 3 performs predetermined signal processing upon the TS which is inputted. The decoder 3 separates out signals of various types, such as a video signal, an audio signal, a signal which specifies information about the virtual channels, and so on, and inputs these signals to the control unit 4.

The control unit 4 controls the operation of the various sections of the main body of this digital television. The details of the control performed by this control unit 4 will be described hereinafter.

The actuation unit 5 receives input actuation, and transmits commands which have been inputted to the control unit 4. This actuation unit 5 comprises a plurality of actuation keys and a remote control reception unit which receives signals transmitted from a remote control. On this remote control, there are provided a plurality of actuation keys, which are the same as some or all of the actuation keys provided to the actuation unit 5. By the user actuating the remote control, he can perform input actuation to change the physical channel, change the virtual channel, adjust the sound volume, and so on.

The storage unit 6 comprises a non-volatile memory (for example an EEPROM or a flash memory) and a volatile memory which is backed up by a battery (for example a SDRAM). This storage unit 6 stores channel information which will be described hereinafter, the time instant at which the physical channel was most recently tuned, and so on. Moreover, the storage unit 6 stores a time instant at which tuning failed during a first timeout period, as will be described hereinafter.

The display unit 7 comprises, for example, a liquid crystal display, an organic EL display, or the like. On the basis of a signal which is inputted from the control unit 4, this display unit 7 displays images, character information, and the like.

The audio output unit 8 consists of a speaker or the like. This audio output unit 8 outputs audio on the basis of a signal which is inputted from the control unit 4.

The timer 9 times the present date and time. Moreover, this timer 9 inputs the time instant at which the physical channel is changed to the storage unit 6 via the control unit 4.

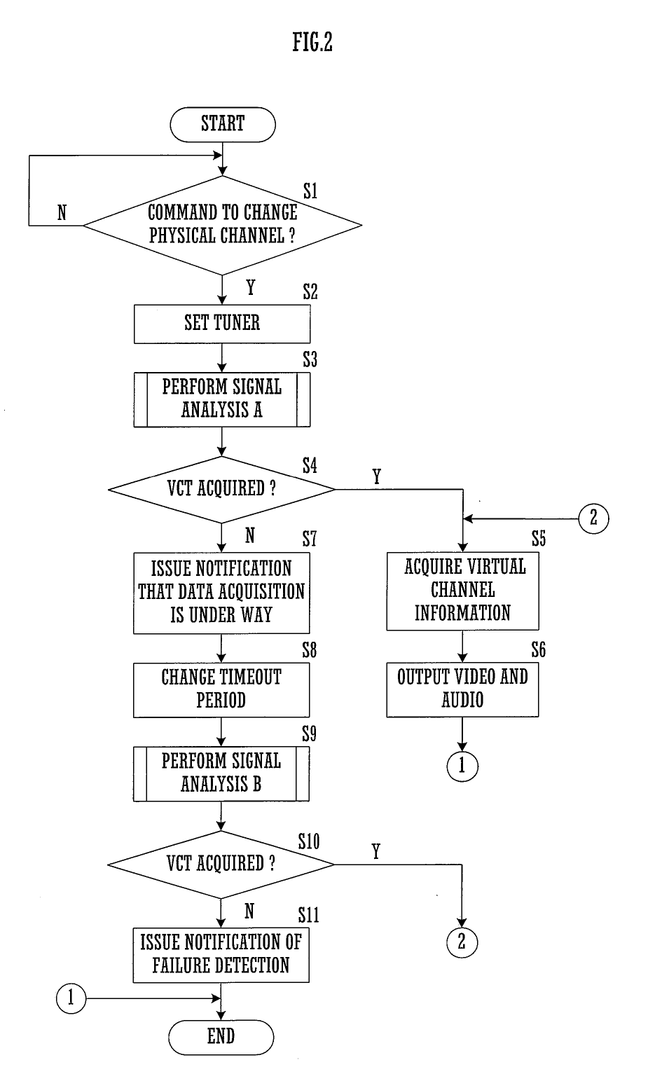

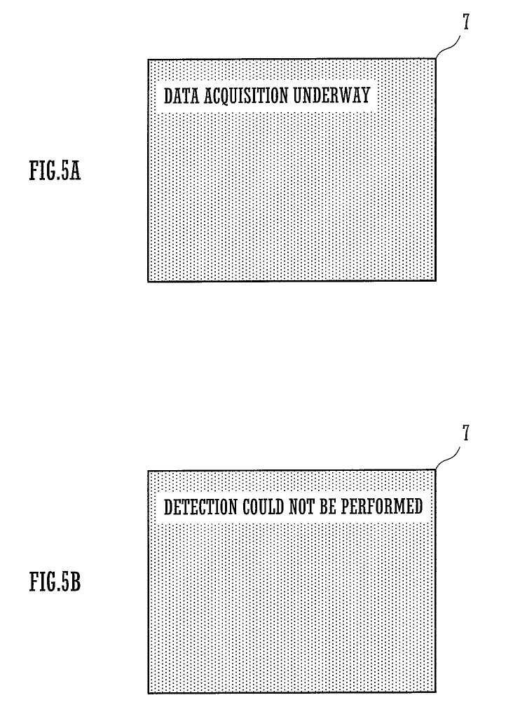

In the following, the operation of this digital television 1 will be explained on the basis of FIGS. 2 through 5. FIGS. 2 through 4 are flow charts showing various processes performed by the control unit 4. And FIG. 5 shows examples of display screens which are displayed upon the display unit 7 by the processing of steps S7 and S11 which will be described hereinafter.

The control unit 4 waits until a command to change the physical channel is issued (a step S1). Then it sets the tuner 2 to the frequency of the physical channel to be tuned (a step S2). Due to this, the tuner 2 acquires the digital broadcast signal which is inputted from the antenna 20 on the frequency band of the physical channel which has been tuned. And the tuner 2 inputs the TS of the physical channel which has been tuned to the decoder 3. Thus the decoder 3 separates out, from the TS which has been inputted, the various signals for the video signal, the audio signal, the control signal, and so on. And the decoder 3 outputs these signals to the control unit 4.

The control unit 4 then executes a signal analysis routine A which performs analysis upon the signals which have thus been inputted (a step S3).

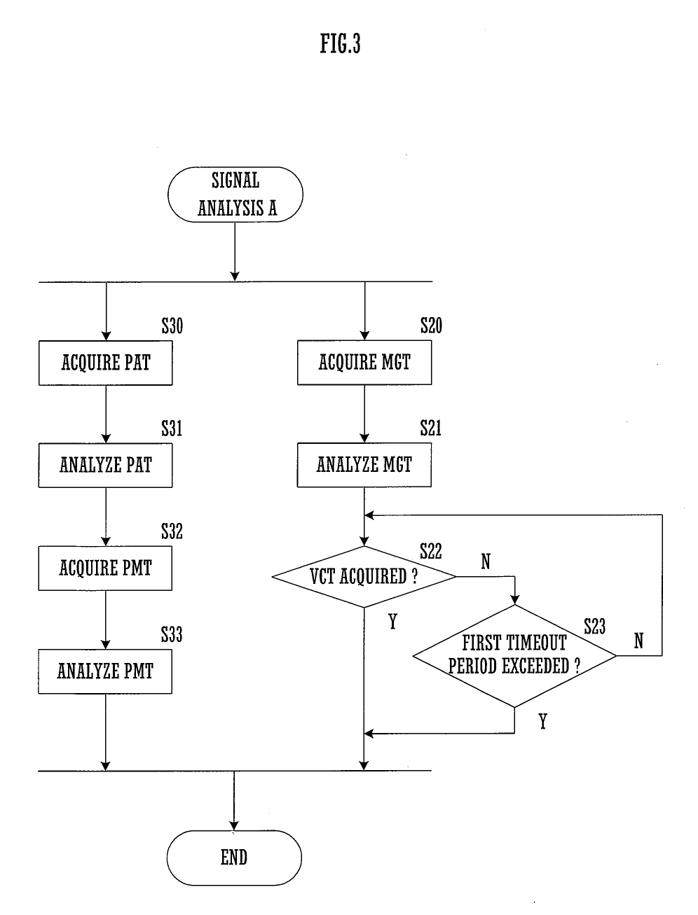

In the signal analysis routine A shown in FIG. 3, the control unit 4 acquires an MGT (Master Guide Table) and a PAT (Program Association Table) from among the signals which has been inputted from the decoder 3 (steps S20 and S30). And the control unit 4 performs analysis upon each of these (steps S21 and S31). Now, the PIDs (Packet IDentifier) of the VCT are described in the MGT. Due to this, by analyzing the MGT and acquiring the PID of the VCT, the control unit 4 is able to assemble the VCT from among the signals which are inputted from the decoder 3. Moreover, the PAT is a table which gives a list of the programs which are included in the TS by a list of the PIDs of PMTs (Program Map Tables). One of the PMTs is a table in which PIDs of images and audio and the like included in a program are stored. In other words, the control unit 4 acquires a PMT from the PAT, and acquires the PIDs of images and audio and the like included in the program from the PMT. By doing this, the control unit 4 is able to display the video of the program upon the display unit 7, and to output the audio of the program from the audio output unit 8.

The control unit 4 decides whether or not it is possible to acquire the VCT from the information in the MGT (a step S22). And, if it is decided that the VCT cannot be acquired (N in the step S22), then the control unit 4 makes a decision as to whether or not the time period from when change of the physical channel was performed to the present moment is greater than a first timeout period (for example, 500 ms) (a step S23). This decision is performed on the basis of the time instant that the physical channel was tuned, which is stored in the storage unit 6, and the time period timed by the timer 9.

If it is decided that the first timeout period has not elapsed (N in the step S23), then the control unit 4 acquires the VCT for a second time. And the control unit 4 terminates this period at the time point (Y in the step S22) that the VCT has been acquired. If the VCT is transmitted in the normal manner, it is possible to acquire the VCT rapidly at this time point.

However, if it is decided that the first timeout period has elapsed, then the control unit 4 terminates this processing (Y in the step S23).

On the other hand, the control unit 4 acquires the PMT from the PAT (a step S32), and performs analysis of the PMT (a step S33). And, from the PMT, the control unit 4 is able to acquire the video and audio and so on of the program upon the physical channel which is currently tuned.

It should be understood that the control unit 4 performs the processing of the steps S20 through S23 and the processing of the steps S30 through S33 in parallel. Even if one of these processes has terminated quickly, the control unit 4 waits until the other one of the processes terminates, and does not immediately end this signal analysis routine A.

When the signal analysis routine A (the step S3) ends, the control unit 4 decides (a step S4) whether or not the result of this signal analysis processing (of the step S3) is that it has been possible to acquire the VCT. Here, if it is decided (Y in the step S4) that the VCT has been acquired by the processing in the step S22, then the control unit 4 acquires, from the information in the VCT, the channel information about the virtual channels, which is included in the currently tuned physical channel (a step S5). The channel information about the virtual channels specifies a main channel and at least one sub-channel which are the virtual channels. On the basis of this channel information about the virtual channels, the control unit 4 establishes a correspondence between the PIDs of the video and the audio of the program which have been acquired from the PMT, and the main channel and at least one sub-channel which are the virtual channels. And the control unit 4 stores correspondence information in which these two are kept in correspondence, in the storage unit 6. Due to this, when the user changes the virtual channel, on the basis of the correspondence information which is stored in the storage unit 6, the control unit 4 displays the video of the program which corresponds to the virtual channel after change upon the display unit 7, and outputs the audio of the program which corresponds to the virtual channel after change to the audio output unit 8 (a step S6).

On the other hand, if the result of the signal analysis routine (of the step S3) is that it has not been possible to acquire the VCT (N in the step S4), then the control unit 4 issues a command (the step S7) to the display unit 7 to display a first screen which gives a notification that data acquisition is currently under way. Due to this, the display unit displays the first screen shown in FIG. 5(A).

And the control unit 4 changes the timeout period for the signal analysis routine B (of a step S9) to a second timeout period which is longer than the first timeout period the previous time (a step S8). For example, since the first timeout period is 500 ms, the control unit 4 may change the second timeout period to 2 s.

When this change of the timeout period has been performed, the control unit 4 executes a signal analysis routine B (a step S9).

This signal analysis routine B of the step S9 is almost the same as the signal analysis routine A of the step S3. In detail, the control unit 4 re-acquires the MGT, and performs analysis of the MGT which it has analyzed. And the control unit 4 decides whether or not it has been possible to acquire the VCT from the MGT (steps S40 through S42). Moreover, the control unit 4 re-acquires the PAT, and analyzes the PAT which it has acquired. And the control unit 4 acquires the PMT from the PAT, and performs analysis of the PMT (steps S50 through S53).

If it is decided that the VCT cannot be acquired (N in the step S42), then the control unit 4 makes a decision as to whether or not the time period from when it was decided in the step S4 that acquisition of the VCT the previous time could not be performed, until the present moment, is greater than the second timeout period (a step S43). This decision is performed on the basis of the time period timed by the timer 9. Moreover, as described above, the time instant when it was decided in the step S4 that acquisition of the VCT the previous time could not be performed is recorded in the storage unit 6.

If it is decided that the second timeout period has not elapsed (N in the step S43), then the control unit 4 acquires the VCT for a second time (the step S42) And the control unit 4 terminates this processing at the time point (Y in the step S43) that the VCT has been acquired in the step S42. And the control unit 4 terminates this processing at the time point (Y in the step S43) that the VCT has been acquired in the step S42. Here, since the second timeout period is set to be longer than the first timeout period, accordingly, even if the VCT has not been sent in the normal manner, still it is possible to acquire the VCT at this time point simply and easily.

On the other hand, if it is decided that the second timeout period has elapsed (Y in the step S43), then the control unit 4 terminates this processing.

It should be understood that the control unit 4 performs the processing of the steps S40 through S43 and the processing of the steps S50 through S53 in parallel. Even if one of these processes has terminated quickly, the control unit 4 waits until the other one of the processes terminates, and does not immediately execute the processing of the following step S10 and subsequently.

Then the control unit 4 decides whether or not the result of the signal analysis routine B this time (in the step S9) is that, this time, it has been possible to acquire the VCT (a step S10). Here, if it is decided that it has been possible to acquire the VCT (Y in the step S10), then the control unit 4 performs the processing of the steps S5 and S6.

On the other hand, if the result of the signal analysis routine in the step S9 is that, even this time, it has not been possible to acquire the VCT (N in the step S10), then the control unit 4 commands the display unit 7 to display a second screen which issues a notification to the effect that notification has not been possible. Due to this, the display unit displays the second screen shown in FIG. 5(B), and then the control unit 4 terminates this processing.

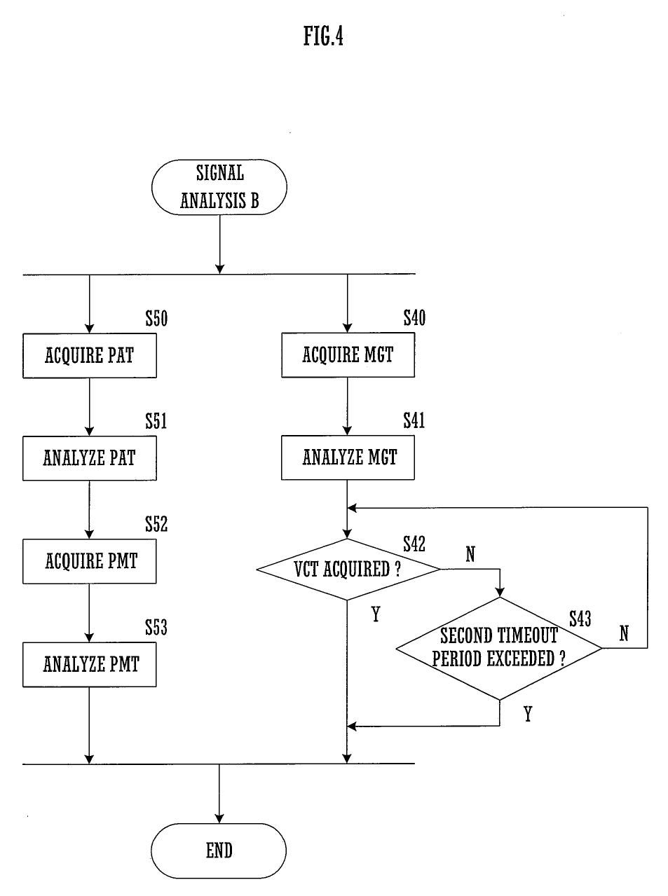

By the above, if the VCT is being transmitted in the normal manner, then it is possible to acquire the VCT rapidly with the signal analysis routine A shown in FIG. 3. Due to this, it is possible for the user to view the program rapidly. Furthermore, since the second timeout period is set to be longer than the first timeout period, accordingly, even if the VCT is not being transmitted in the normal manner, it is possible to acquire the VCT simply and easily with the signal analysis routine B shown in FIG. 4. Due to this it is possible to acquire the channel information for the virtual channels, even if it would not have been possible to acquire such channel information for the virtual channels according to the prior art. Accordingly, the user is able to view the programs on the virtual channels of the physical channel.

Moreover, when it is not possible to perform acquisition during the first timeout period, the first screen which notifies the user that data acquisition is still being performed is displayed upon the display unit 7. Due to this, it becomes difficult for the user to misunderstand and think that no virtual channels are present upon the physical channel which is currently tuned. Furthermore, since the second screen which notifies the user that detection has not been possible is displayed upon the display unit 7 when acquisition has not been possible within the second timeout period, accordingly the user is able to know that no virtual channels are present upon the physical channel which is currently tuned.

Moreover, the actuation unit 5 or the remote control may have a prevent key which receives control operation to prevent the timeout period from being changed. When, with this structure, the user actuates this prevent key, the control unit 4 skips the step (S8) in which the timeout period is changed. Due to this, the user is able to prevent change of the timeout period, according to his own manner of use.

It should be understood that although, in this embodiment, the timeout period until acquisition of the VCT is changed, it would also be possible to change a timeout period until an EIT (Event Information Table) is acquired. The EIT is a table which specifies information related to the programs which are broadcast upon the virtual channels. By doing this, the acquisition of the EIT may be performed simply and easily, in a similar manner to the acquisition of the VCT.

Furthermore although, in this embodiment, the control unit 4 displays the first screen and the second screen upon the display unit 7 as appropriate, it would also be acceptable to display upon the display unit 7, not complete screens, but rather corresponding first character information and second character information. Moreover, the above described first timeout period and second timeout period may be set to different time periods from those described. For example, it would be acceptable to set the first timeout period to 450 ms, and to set the second timeout period to 1.8 s.

Moreover, the present invention could also be applied to a digital broadcast reception device other than a digital television, for example to a STB (Set Top Box).

What is claimed is:

1. A digital broadcast reception device, comprising:
a reception means which receives a digital broadcast signal upon a physical channel which has been tuned;
an acquisition means which performs acquisition processing in which information about virtual channels included upon said digital broadcast signal is acquired from said digital broadcast signal, until a first timeout period has elapsed;
a decision means which decides whether or not said acquisition means has been able to acquire said information about virtual channels within said first timeout period;
and a change means which changes said timeout period to a second timeout period which is longer than said first timeout period, when said decision means has decided that said acquisition means has not been able to acquire said information about virtual channels within said first timeout period;
and wherein:
said acquisition means performs said acquisition processing after said change means has performed change of the timeout period, until said second timeout period has elapsed; and
said decision means decides whether or not said acquisition means has been able to acquire said information about virtual channels within said second timeout period.

2. A digital broadcast reception device according to claim 1, further comprising an output means which outputs an image; and wherein said output means outputs a first image which notifies the user that information about said virtual channels is being acquired, when said decision means has decided that said acquisition means has not been able to acquire said information about said virtual channels within said first timeout period.

3. A digital broadcast reception device according to claim 2, wherein said output means outputs a second image which notifies the user that information about said virtual channels cannot be acquired, when said decision means has decided that said acquisition means has not been able to acquire said information about said virtual channels within said second timeout period.

4. A digital broadcast reception device according to claim 1, further comprising an actuation means which receives a prohibition for change by said change means of said timeout period.

5. A digital broadcast reception device according to claim 1, wherein said acquisition means acquires, as said information about said virtual channels, channel information which specifies a main channel and at least one sub-channel which are the virtual channels.

6. A digital broadcast reception device according to claim 1, wherein said acquisition means acquires, as said information about said virtual channels, program information specifying information relating to programs which are broadcast upon said virtual channels.
